(19) United States
(12) Patent Application Publication
(10) Pub. No.: US 2008/0235896 A1
(43) Pub. Date: Oct. 2, 2008

(54) Wiper blade structure

(76) Inventor: Ming-Hui Cheng, Taipei (TW)

Correspondence Address: TROXELL LAW OFFICE PLLC, SUITE 1404, 5205 LEESBURG PIKE, FALLS CHURCH, VA, 22041, US

(21) Appl. No.: 11/727,900

(22) Filed: Mar. 28, 2007

(51) Int. Cl. B60S 1/38

(52) U.S. Cl. 15/250.201

(57) ABSTRACT

A wiper blade structure comprises a pivot assembly, a plurality of deflectors, a plurality of end ferrule caps, a resilient strip, and a blade element. The pivot assembly may comprise a connecting adapter for engaging various wiper arms and the connecting adapter is further coupled with a pivot socket settled on the resilient strip, so that the connecting adapter can be easily connected with various wiper arms. Besides, by the combining structure among the pivot socket, end ferrule caps and the resilient strip, as well as the combination among the deflectors, resilient strip and the blade element, the wiper blade can firmly and closely contact the windshield glass, so that the defects of the conventional wiper blade structures can be remedied. Thus, the disclosed subject matter can perform improved efficiency of use and therefore is an invention having utilitarian value.

### BACKGROUND OF THE INVENTION

1. Technical Field

The present invention relates to a wiper blade and, more particularly, to an assembled structure of a wiper blade that is compatible with various wiper arms of a vehicle and facilitates tight, and firm contact between the wiper blade and the windshield glass so as to remedy the drawbacks of the conventional wiper blade structure.

2. Description of Related Art

Presently, many different types of wiper blade structures have been provided for addressing some particular problems. For instance, Taiwan Patent M269236 (Application Number 93212160) discloses a wiper blade structure that is compatible with a variety of wiper arms of vehicles. More particularly, the wiper blade structure of M269236 implements a connector and some accessories for being collocated with the connector to satisfy the different demands of different structures of wiper arms. However, with the increment of the components of the wiper blade, the manufacturing cost can be immediately raised. Meantime, during actual use, since the consumer can merely choose one of the accessories to use, the unchosen accessories are left aside and thus wasted. Thus, such a strategy still has shortcomings. Further, in Taiwan Patent M274290 (Application Number 94207166), a pivot socket of a fulcrum-less flexible wiper blade is disclosed. In the same Patent, U.S. Pat. Nos. 6,687,948 and 6,799,348 are mentioned as related prior arts. The recited wiper blade structure of one of the prior arts is characterized by the jointing structure between a pivot socket and a resilient strip thereof, wherein two pairs of clips are provided on the pivot socket to engage a plurality of indentations correspondingly arranged at the lateral edges of the resilient strip. For such a structure, high precision is required of the processing process; otherwise, the joints between the pivot socket and the resilient strip may be liable to loosening, and the efficiency of windshield wiping can be consequently depressed. Thus, the recited remedy is a novel fulcrum-less flexible wiper blade that is constructed by inserting a plurality of clips on a pivot socket of a wiper blade into a plurality of retaining holes provided on the resilient strip for making the components fasten mutually. Though the disclosure remedy helps to overcome the disadvantage of loosening joints of the previously recited US Patent, the restriction caused by the coupled clips and retaining holes of the resilient strip can inflexibly limit the elastic deformation of the resilient strip. As a result, since the resilient strip is restrained from natural extension, the pressing force it presents on the windshield glass can become uneven. Besides, it is very difficult to precisely punch the retaining hole, while the punched holes can undesirably affect the elastic deformation of the surrounding resilient strip. In view of theses defects, Patent M274290 implements a connection between a plurality of protrusions and clips settled at the bottom of the pivot socket to avoid foresaid problems. By executing this strategy, no more holes have to be punched on the resilient strip and the undesirable effects upon deformation and strength of the resilient strip can be eliminated. However, the variation of the interval between the protrusions before and after the deformation of the resilient strip may nevertheless cause the socket to shake during windshield wiping. Hence, the defect of failing to wipe cleanly is still uncured.

### SUMMARY OF THE INVENTION

The wiper blade structure of the present invention is provided for remedying the aforementioned drawbacks of the conventional wiper blade structures. The disclosed wiper blade structure provides a novel structure that allows for easy assembly. Also, the disclosed structure is compatible with various types of vehicle wiper arms and facilitates close contact between the wiper blade and the windshield glass, while also allows the manufacturing cost thereof to be reduced.

It is one objective of the present invention to provide a wiper blade structure, which has pin holes and clamping recess provided on the opposite ends, and upper as well as lower edges of the laterals of the connecting adapter and the protective lid of the pivot assembly so as to engage various types of vehicle wiper arms. Thereby the need for additional accessories of the wiper blade assembly can be eliminated, and consequently, the purposes of convenient use and reduced manufacturing cost can be achieved.

It is another objective of the present invention to provide a wiper blade structure, which has rivets provided at the central portion of the pivot socket and positioning pieces arranged at the opposite ends of the pivot socket, for being engaged by rivet recesses provided at the central edges of the resilient strip. By the coupling between the rivets and the rivet recesses as well as the coupling between the positioning pieces and the positioning holes, the pivot socket and resilient strip can be firmly combined. Meantime, when the wiper resilient strip contacts the glass surface, the proper deformation thereof is free from restriction. Additionally, the recesses of the resilient strip are easy to make, but also eliminating the defect of causing stress that may disadvantageously affect the elastic deformation of the resilient strip. Therefore, the function of wiping windshield can be effectively achieved.

It is still another objective of the present invention to provide a wiper blade structure, which has deflectors respectively composed of a rigid rubber strip and a flexible deflecting plate, wherein the rigid rubber strip is capable of engaging various resilient strips by inlay recesses and ribs that are mating mutually and can fix the blade element thereon, whereby the firm assembly as well as the function of wiping windshield can be effectively fulfilled.

### BRIEF DESCRIPTION OF THE DRAWINGS

The invention as well as a preferred mode of use, further objectives and advantages thereof, will best be understood by reference to the following detailed description of an illustrative embodiment when read in conjunction with the accompanying drawings, wherein:

FIG. 1 is a perspective view of one preferred embodiment of the present invention;

FIG. 1-1 is a perspective view of another preferred embodiment of the present invention;

FIG. 1-2 is a perspective view of yet another preferred embodiment of the present invention;

FIG. 2 is an exploded view of the embodiment of FIG. 1;

FIG. 2-1 is an exploded view of the second embodiment of FIG. 1-1;

FIG. 2-2 is an exploded view of the third embodiment of FIG. 1-2;

FIG. 3 is an applied view showing the use of one embodiment of the connecting adapter of the pivot assembly according to the present invention;

FIG. 3-1 is an applied view showing the use of another embodiment of the connecting adapter of the pivot assembly according to the present invention;

FIG. 4 is an applied view showing the use of one embodiment of the pivot socket of the pivot assembly according to the present invention;

FIG. 4-1 is an applied view showing the use of another embodiment of the pivot socket of the pivot assembly according to the present invention;

FIG. 5 is a sectional view of one embodiment of the deflector according to the present invention;

FIG. 6 is a schematic drawing showing the assembly of the end ferrule caps an the resilient strip of one preferred embodiment of the present invention;

FIG. 6-1 is a schematic drawing showing the assembly of the end ferrule caps an the resilient strip of another preferred embodiment of the present invention; and

FIG. 7 is a lateral view of the rigid rubber strip according to one preferred embodiment of the present invention.

### DETAILED DESCRIPTION OF THE PREFERRED EMBODIMENT

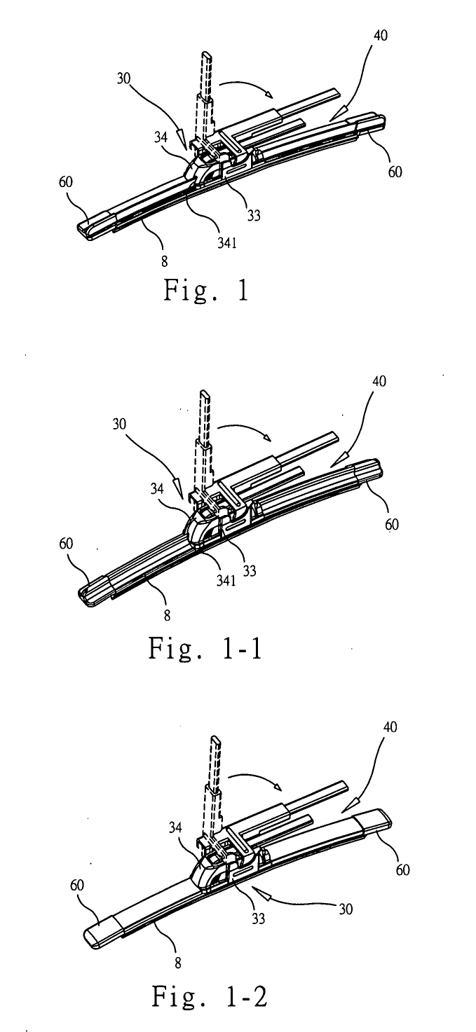

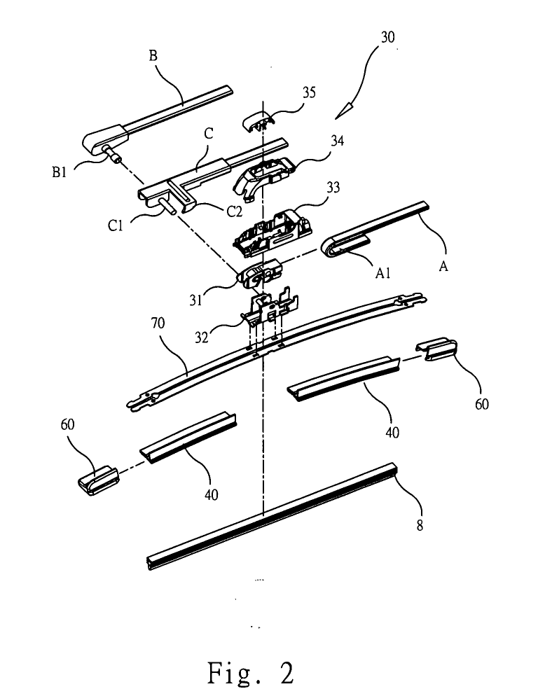

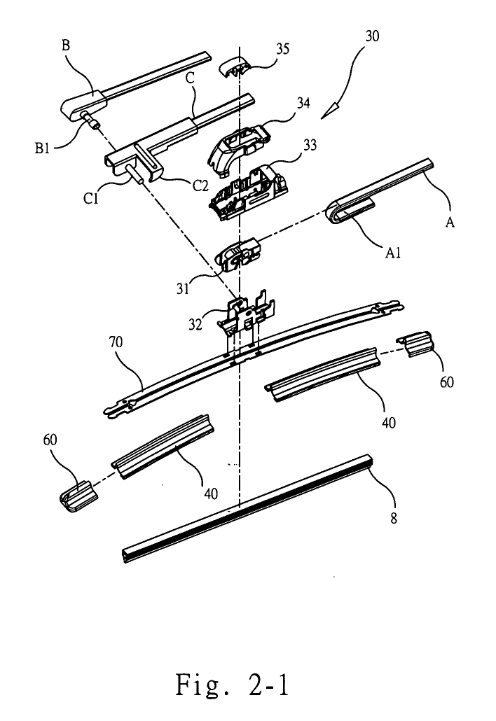

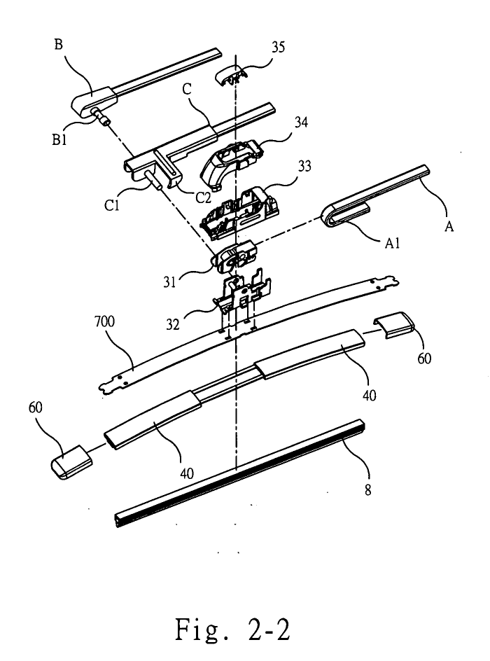

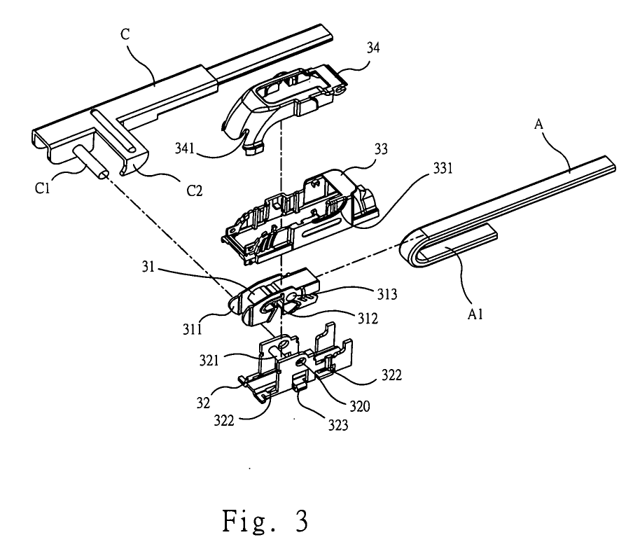

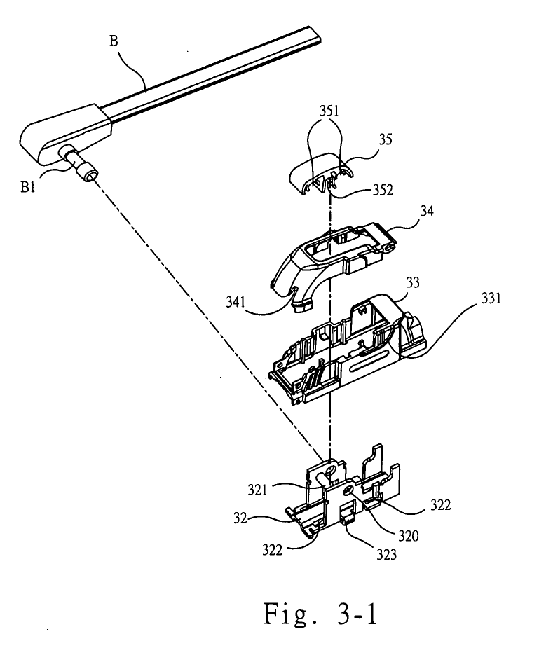

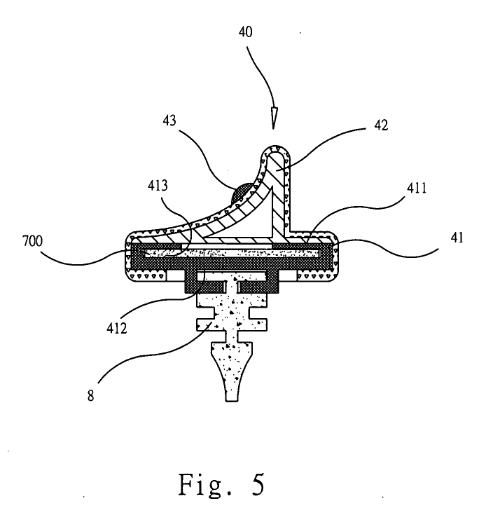

Please refer to FIG. 1 for the assembly drawing of one preferred embodiment of the present invention. The disclosed wiper blade structure comprises a pivot assembly 30, a plurality of deflectors 40, a plurality of end ferrule caps 60, a resilient strip 70 (as shown in FIG. 2), and a blade element 8. The pivot assembly 30 further comprises a connecting adapter 31 and a pivot socket 32. As can be seen in FIG. 2, a protective casing 33 and a protective lid 34 are provided around the periphery of the connecting adapter 31 and the pivot socket 32 for the purpose of protection. Thereupon, by connecting the connecting adapter 31, the protective casing 33 and the protective lid 34 with a vehicle wiper arm, and then connecting the said assembly with the resilient strip 70 and the blade element 8 by means of the pivot socket 32, the wiper blade can be assembled with the vehicle wiper arm. Each of the deflectors 40 is composed of a rigid rubber strip 41 and a flexible deflecting plate 42 (as shown in FIG. 5). The flexible deflecting plate 42 may be of a side-beam type (as shown in FIG. 1), a central-beam type (as shown in FIG. 1-1) or an arched-beam type (as shown in FIG. 1-2) depending upon a user's demand. For fitting foresaid different types of the deflectors 40, the protective lid 34 may have retaining notches 341 correspondingly arranged at the edge of the lateral thereof (as shown in FIG. 3) or arranged at the center of the lateral thereof (as shown in FIG. 3-1) for retaining the flexible deflecting plate 42 therein. Alternatively, the protective lid 34 may be provided for fitting the deflectors 40 of the arched-beam type (as shown in FIGS. 1-2 and 2-2). Furthermore, the two end ferrule caps 60 can also be properly shaped to fitly engage with the deflectors 40 of different types, so that the resilient strip 70 and the blade element 8 can be assembled with the deflectors 40. Particularly, in the deflectors 40, an upper end 411 and the periphery of the rigid rubber strip 41 are wrapped by the lower end of the flexible deflecting plate 42 whereby the connection between the rigid rubber strip 41 and the flexible deflecting plate 42 of the deflectors 40, as shown in FIG. 5, is accomplished. Then the rigid rubber strip 41 may further grip the blade element 8 with an insert recess 412 provided at the bottom thereof, while also connect with the resilient strip 70 (a single-piece resilient strip 700 is depicted herein for instance.) at another insert recess 413 provided at the upper end thereof. Besides, a fluorescent strip 43 may be deposited on the windward surface at the upper end of the flexible deflecting plate 42. At last, when the end ferrule caps 60 cap onto the opposite ends of the assembled resilient strip 70 respectively and enclose the ends of the deflectors 40 entirely, the wiper blade can be thus firmly assembled.

Please refer to FIG. 3 for the use of the connecting adapter 31 of the pivot assembly 30. A clamping recess 311 is provided at one end of the connecting adapter 31 for being engaged by a hook A1 of a hook-type wiper arm A of a vehicle-driven windshield wiper. Moreover, a connecting recess 331 is provided at one lateral of the protective casing 33, while an inlay recess 312 is provided at the lower end of the connecting adapter 31 for receiving a shaft 321 of the pivot socket 32 of the pivot assembly 30 (as shown in FIG. 3). Thereby, the connecting adapter 31 and the pivot socket 32 can be connected and retained mutually. Then, the protective casing 33 and the protective lid 34 can be mounted and fixed around the pivot socket 32 for receiving a pivot-joint wiper arm C that has a pivot pin C1 and a bent end C2. To assemble the pivot-joint wiper arm C with the pivot assembly 30, the wiper arm C is connected with the pivot assembly 30 perpendicularly (as shown in FIG. 1) in the manner that the pivot pin C1 is inserted into pin holes 313, 320 of the connecting adapter 31, and the pivot socket 32 and the wiper arm C is then rotated to make the hook C2 get engaged by the clamping recess 331 of the protective casing 33. For a insertion-type wiper arm B, as shown in FIG. 3-1, a connecting pin B1 (with two end having enlarged diameters and with a shaft having various diameters) can be also inserted into the pin holes 320 of the pivot socket 32 so as to achieve the combination between the insertion-type wiper arm B and the pivot assembly 30 directly. Meantime, the pivot assembly 30 further comprises a connector 35 for being inserted onto the protective lid 34. Plural clips 351 (may be sized to fitly receive the shaft of the connecting pin B1 with various diameters) provided at the bottom of the connector 35 facilitate firmly fixing the connecting pin B1. Further, an inlay recess 352 is further provided at the lower end of the connector 35 for receiving the shaft 321 of the pivot socket 32 so as to realize the assembly of the connector 35 and the pivot socket 32. Thereupon, the pivot assembly 30 is capable of engaging various vehicle wiper arms A, B and C without the need of any additional accessories. Accordingly, not only a user can assemble the wiper blade with a wiper arm conveniently, but the manufacturing cost as well as the waste of resources can also be reduced. Thus, the disclosed subject matter can successfully overcome the aforementioned defects of the conventional windshield wiper components.

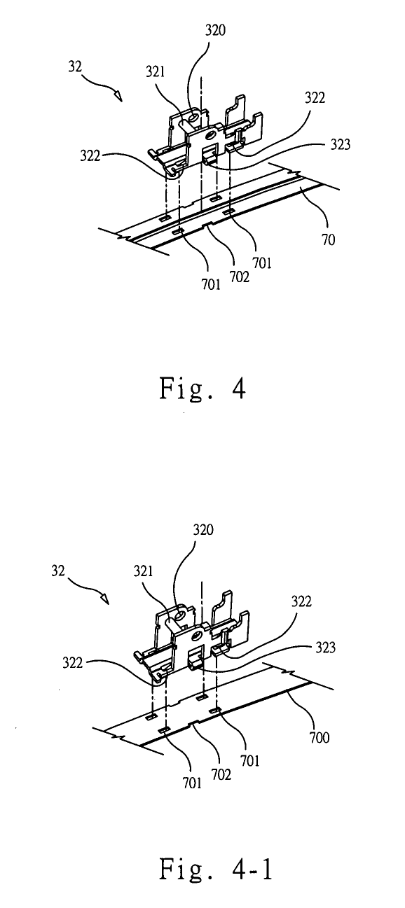

Besides, the pivot socket 32 further comprises a plurality of positioning pieces 322 at the opposite ends thereof and a plurality of rivets 323 deposited at the central portion thereof for being coupled with the resilient strip 70. As shown in FIG. 4, on a resilient strip 70 of a symmetrical dual-piece type, a plurality of positioning holes 701 are settled at the central portion thereof corresponding to the positioning pieces 322, while a plurality of rivet recesses 702 are provided at the central edges thereof corresponding to the rivets 323. Thus, when the positioning pieces 322 are inserted into the corresponding positioning holes 701, and the rivets 323 of the pivot socket 32 are engaged by the rivet recesses 702 of the resilient strip 70, the pivot socket 32 and the resilient strip 70 can be assembled. Alternatively, a single-piece resilient strip 700 can also be fastened by the same structure (as shown in FIG. 4-1). Through such assembly structure, the wiper resilient strip 70 or 700 can maintain an arched shape with appropriate elasticity when not contacting a windshield glass surface. When the wiper resilient strip 70 or 700 contacts the glass surface, an appropriate amount of deformation can be performed in virtue of the elasticity of the wiper resilient strip 70 or 700, so that the blade element 8 installed on the wiper resilient strip 70 or 700 can closely contact the glass. At this time, since the positioning pieces 322 are provided at the central portion of the resilient strip 70 or 700, no restriction may occur against the deformation of the resilient strip 70 or 700. Thus, the drawbacks of the conventional resilient strips having pin holes punched thereon can be eliminated. Additionally, as the rivets 323 of the pivot socket 32 and the resilient strip 70 or 700 are mutually combined in such means, the previous problem of undesirable looseness between the two components caused by the enlarged intervals resulted from the deformation of the resilient strip can be avoided. In addition, since the positioning holes 701 are located near the edges of the resilient strips 70, 700, the same are easy to be punched and made. Hence, the disclosed subject matter can efficiently overcome the drawbacks of the conventional wiper blade structure.

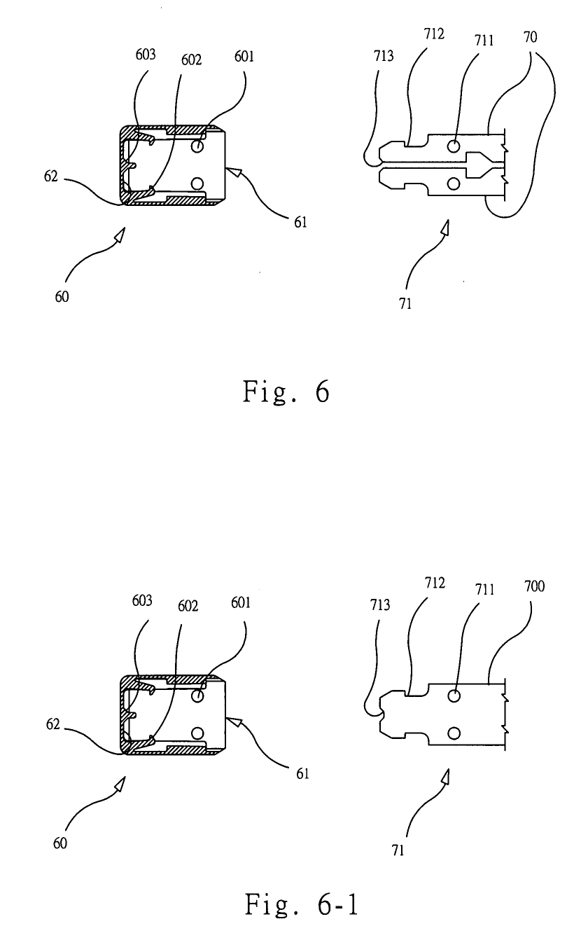

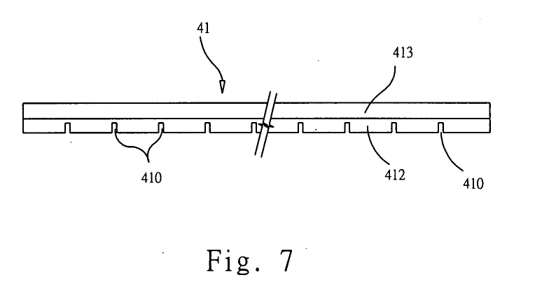

Furthermore, the connection between the end ferrule caps 60 and the resilient strips 70, 700 is illustrated in FIG. 6-1. At the inner bottom surface of each said end ferrule cap 60, a pair of columns 601, a pair of one-way hooks 602 and a triangular revetment 603 for the purpose of positioning are successively arranged between the opening end 61 and the inner surface 62. Meantime, the resilient strip 70 or 700 correspondingly comprises a triangular guiding recess 713 at each end of either the dual-piece or single-piece strip respectively. Also, a pair of indentations 712 is provided near each end of the resilient strip 70 or 700 while a pair of retaining holes 711 is arranged on the strip(s) for each end thereof. Thereby, when each said end ferrule cap 60 is assembled with the resilient strip 70 or 700, the corresponding triangular guiding recess 713 and the triangular revetment 603 come to lean against each other, so that the one-way hooks 602 can engage the indentations 712 at the edges of the strip 70 while the columns 601 are respectively retained by the retaining holes 711 provided on the strip 70. Thereby, a triple-combination structure can be achieved. Then the assembled end ferrule caps 60 can further cover the deflectors 40 downward. Additionally, the rigid rubber strip 41 of the deflectors 40 holds the blade element 8 by the insert recess 412, while a plurality of gaps 410 may be provided on the insert recess 412 spaced with equal intervals, as shown in FIG. 7, so that when the resilient strip 70 or 700 is properly bent or deformed, the gaps 410 allow the blade element 8 inlaid in the insert recess 412 to become bent or deformed correspondingly. Therefore, a complete wiper blade structure is realized.

Although a particular embodiment of the invention has been described in detail for purposes of illustration, it will be understood by one of ordinary skill in the art that numerous variations will be possible to the disclosed embodiments without going outside the scope of the invention as disclosed in the claims.

What is claimed is:

1. A wiper blade structure comprising a pivot assembly, a plurality of deflectors, a plurality of end ferrule caps, a resilient strip, and a blade element, wherein,
the pivot assembly comprises a connecting adapter and a pivot socket wherein the connecting adapter is for engaging a windshield wiper arm for a vehicle and after the connecting adapter is connected with the pivot socket, the resilient strip and the blade element can be assembled thereto;
each said deflector is made from more than one material and formed into a strip for being settled on the resilient strip;
the end ferrule caps are settled at the opposite ends of the resilient strip and cover the deflectors respectively; and
the resilient strip is composed of two symmetrical strips and has positioning components provided at the central portion and two opposite ends thereof for coupling with and engaging the pivot socket of the pivot assembly and the ferrule caps.

2. The wiper blade structure of claim 1, wherein the pivot assembly comprises a clamping recess provided at one end thereof, an inlay recess provided at lower end thereof and two pin holes provided at the two laterals thereof.

3. The wiper blade structure of claim 1, wherein a protective casing and a protective lid are mounted around the periphery of the connecting adapter and the pivot socket for the purpose of protection.

4. The wiper blade structure of claim 3, wherein a connecting recess is provided at one lateral of the protective casing.

5. The wiper blade structure of claim 3, wherein a plurality of retaining notches is provided at the edges or the center of the lateral of the protective lid.

6. The wiper blade structure of claim 1, wherein the pivot assembly further comprises a connector for being inserted onto the protective lid, wherein a plurality of clips are provided at the lower end of the connector.

7. The wiper blade structure of claim 1, wherein the pivot socket comprises a shaft and a plurality of pin holes, and the pivot socket further comprises two positioning pieces at the opposite ends thereof and a plurality of rivets deposited at the central portion thereof.

8. The wiper blade structure of claim 1, wherein the deflectors is composed of a rigid rubber strip and a flexible deflecting plate wherein the flexible deflecting plate is of a side-beam type, a central-beam type or an arched-beam type.

9. The wiper blade structure of claim 8, wherein a fluorescent strip is deposited on the windward surface at the upper end of the flexible deflecting plate.

10. The wiper blade structure of claim 8, wherein the rigid rubber strip comprises an insert recess provided at the upper end thereof for engaging the resilient strip, and comprises another insert recess provided at the lower end thereof for engaging the flexible deflecting plate.

11. The wiper blade structure of claim 8, wherein a plurality of gaps is provided at the lower end of the insert recess spaced with equal intervals.

12. The wiper blade structure of claim 1, wherein a pair of columns, a pair of one-way hooks, and a triangular revetment are successively arranged at the inner bottom surface of each said end ferrule caps between the opening end and the inner surface.

13. The wiper blade structure of claim 1, wherein the resilient strip is of a single-piece type and has positioning components provided at the central portion and two opposite ends thereof for coupling with and engaging the pivot socket of the pivot assembly and the ferrule caps.

14. The wiper blade structure of claim 1, wherein the positioning components of the resilient strip are positioning holes and rivet recesses for coupling with the pivot socket of the pivot assembly.

15. The wiper blade structure of claim 1, wherein the positioning components of the resilient strip are two triangular guiding recesses respectively settled at the opposite ends of the two abreast strips, a plurality of indentations provided near the edges of the resilient strip, and a plurality of retaining holes arranged on the abreast strips for being coupled with the end ferrule caps.
